(19) United States
(12) Patent Application Publication
(10) Pub. No.: US 2021/0379887 A1
(43) Pub. Date: Dec. 9, 2021

(54) PRINTING SYSTEMS INCLUDING A RIGID PRINTING PATTERN AND AN INKING ROLL HAVING AN ELASTICALLY DEFORMABLE SURFACE

(71) Applicant: 3M INNOVATIVE PROPERTIES COMPANY, St. Paul, MN (US)

(72) Inventors: Matthew R. D. Smith, Woodbury, MN (US); Shawn C. Dodds, St. Paul, MN (US); Mikhail L. Pekurovsky, Bloomington, MN (US); Thomas J. Metzler, St. Paul, MN (US); Matthew S. Stay, Minneapolis, MN (US); Kara A. Meyers, Oakdale, MN (US); Samad Javid, Woodbury, MN (US)

(21) Appl. No.: 17/284,535

(22) PCT Filed: Oct. 14, 2019
(86) PCT No.: PCT/IB2019/058752

§ 371 Date: Apr. 12, 2021

Related U.S. Application Data
(60) Provisional application No. 62/783,823, filed on Dec. 21, 2018.
(60) Provisional application No. 62/746,674, filed on Oct. 17, 2018.

(51) Int. Cl. B41F 31/26; B41F 5/24; B41F 13/18

(52) U.S. Cl. CPC B41F 31/26; B41F 13/18; B41F 5/24

(57) ABSTRACT

A printing system is provided. The printing system (300) includes a printing roll (310) having a rigid printing pattern (312) on a surface thereof configured to receive an ink material (330); and an inking roll (320) positioned adjacent to the printing roll. The inking roll includes an elastically deformable surface and a number of cells (324) disposed on the elastically deformable surface. A method of printing is also provided. The method includes (a) inking at least a portion of a rigid printing pattern (312) on a surface of a printing roll (310) by contacting the rigid printing pattern with an inking roll (320); and (b) contacting the rigid printing pattern with a substrate (350), transferring the ink material from the rigid printing pattern to a surface of the substrate. Printing systems and methods can achieve higher printing feature resolutions than typically achievable via flexographic printing.

### TECHNICAL FIELD

The present disclosure relates to printing systems and processes including both a rigid printing pattern and an inking roll having a deformable surface.

### BACKGROUND

Flexographic printing technology is widely used in industry as a graphics based printing method, targeting the packaging and labeling industry. Flexographic printing is a popular choice in this industry as it can support a wide variety of substrates and inks, while delivering product at high web speeds. The purpose of using a soft or compressible tool, often in combination with a foam tape, is to make the plate versatile and able to deform to allow for printing on a variety of surfaces, while also allowing the printing plate to be inked by a rigid anilox roll. A drawback of using this soft and compressible construction is that upon impression against a steel backup roll, the stamp can deform and lose dimensional stability of the printed feature, particularly when the feature has a small width (e.g., under about 20 micrometers). Additionally, it may be difficult to produce features with such small widths in an elastomeric material, leading to practical limitations in the size of features that can be successfully printed.

### SUMMARY

Printing systems and methods for printing patterns having high dimensional stability and high resolution features are provided. In a first aspect, a printing system is provided including a printing roll having a rigid printing pattern on a surface thereof configured to receive an ink material; and an inking roll positioned adjacent to the printing roll. The inking roll includes an elastically deformable surface and a plurality of cells disposed on the elastically deformable surface.

In a second aspect, a method of printing is provided. The method includes (a) inking at least a portion of a rigid printing pattern on a surface of a printing roll by contacting the rigid printing pattern with an inking roll; and (b) contacting the rigid printing pattern with a substrate, transferring the ink material from the rigid printing pattern to a surface of the substrate. The inking roll includes an elastically deformable surface and a plurality of cells disposed on the elastically deformable surface.

Various unexpected results and advantages are obtained in exemplary embodiments of the disclosure. One such advantage of exemplary embodiments of the present disclosure is of printing an ink pattern on a substrate surface having a high resolution and/or highly open printing pattern.

Various aspects and advantages of exemplary embodiments of the disclosure have been summarized. The above Summary is not intended to describe each illustrated embodiment or every implementation of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1A is a schematic cross-sectional diagram of a flexographic printing system, according to the prior art.

FIG. 1B is a schematic portion side view of a rigid anilox roll and a deformable flexographic printing plate, according to the prior art.

FIG. 2A is a schematic cross-sectional diagram of a comparative printing system.

FIG. 2B is an enlarged portion view of the printing system of FIG. 2A, where ink is not successfully transferred from an inking roll to a printing roll.

FIG. 2C is a schematic portion side view of a rigid printing roll and a rigid anilox roll.

FIG. 3A is a schematic cross-sectional diagram of a printing system according to one embodiment of the present disclosure.

FIG. 3B is an enlarged portion view of the printing system of FIG. 3A, where ink is transferred from an inking roll to a printing roll.

FIG. 3C is a schematic portion side view of a printing roll having a rigid printing pattern and an inking roll having an elastically deformable surface, prior to engagement.

FIG. 3D is a schematic portion side view of the rolls of FIG. 3C after engagement.

FIG. 4A is a schematic cross-sectional diagram of an inking roll, according to one embodiment of the present disclosure.

FIG. 4B is a schematic cross-sectional diagram of another inking roll, according to one embodiment of the present disclosure.

FIG. 4C is a schematic cross-sectional diagram of a further inking roll, according to one embodiment of the present disclosure.

FIG. 5 is a schematic cross-sectional diagram of an elastically deformable surface of an inking roll, according to one embodiment of the present disclosure.

FIG. 6 is a schematic cross-sectional diagram of a printing roll contacting an inking roll, according to one embodiment of the present disclosure.

FIG. 7 illustrates a flow diagram of a method of printing an ink pattern, according to one embodiment of the present disclosure.

FIG. 8 is an image of a printed ink pattern, prepared according to Example 1.

In the drawings, like reference numerals indicate like elements. While the above-identified drawings, which may not be drawn to scale, set forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

The term “rigid” refers to an object that has a high flexural stiffness. For a block of homogeneous material with a constant cross-section the flexural stiffness (k) may be calculated using following equation: k=E*I/(1−nu²), where E is the Young's modulus, I is the second moment of a cross-sectional area, and nu is the Poisson's ratio. E and nu are intrinsic material properties, and I is a function of the geometry of the construction. For a slab of material that has thickness t, and width W, second moment of an area per unit width is proportional to the cube of the thickness, and so the flexural stiffness is equal to E*t³/(12*(1−nu²)). When that slab of material is simply supported at the bottom by two parallel ridges separated by a distance L, and uniformly loaded on the top with force per unit width of P, the middle of the slab deflects toward the bottom by the distance Y=5*P*L⁴/(384*k*W). These formulas can be found in (Roark's formulas for stress and strain, 6^{th} ed, NY: McGraw-Hill, 1989, pg. 193). The minimum flexural stiffness for a rigid material as used herein is 0.01 Pa·m³. For reference, a typical flexographic printing plate may have a thickness of about 1.5 mm, an elastic modulus of about 3.6 megaPascals (MPa), and Poisson's ratio of about 0.43 (Bould, D. C. An investigation into quality improvements in flexographic printing. PhD thesis, University of Wales, Swansea, 2001.). Such typical flexographic plate would have a flexural stiffness of about 0.001242 Pa·m³.

The term “elastic” refers to the ability of an object to recover its shape when a deforming force or pressure is removed. The term “elastically deformable” refers to an object (e.g., a thin shell) being capable of substantially 100% (e.g., 99% or more, 99.5% or more, or 99.9% or more) recovering to its original state upon removal of a strain that caused the distortion (e.g., deformation) of the original shape,

The terms “compressible” or “incompressible” refer to a material property, i.e., compressibility, of an object (e.g., an elastomeric layer) which is a measure of the relative volume change of the material in response to a pressure. For example, the term “substantially incompressible” refers to a material having a Poisson's ratio greater than about 0.45.

The term “integral” refers to being composed of portions that together constitute a whole article, as opposed to portions that can be separated from each other without causing damage to the article. For instance, a first part that is attached to a second part with a bolt are not integral to each other, and the first part can be removed from the second part by removing the bolt and without damaging the article, whereas two integrally formed parts would have to be cut, broken, etc., to separate them.

The term “nip” refers to a system of two rolls with (i) a gap between adjacent first and second rolls where the distance between the center of the first and second rolls is greater than or equal to the sum of the radii of the two rolls, or (ii) an impression between adjacent first and second rolls when the distance between the center of the first and second rolls is less than the sum of the radii of the two rolls.

The term “ceramic” includes glass, crystalline ceramic, glass-ceramic, and combinations thereof. The term “glass” refers to amorphous material exhibiting a glass transition temperature. The term “glass-ceramic” refers to ceramic comprising crystals formed by heat-treating glass. The term “amorphous material” refers to material derived from a melt and/or a vapor phase that lacks any long range crystal structure as determined by X-ray diffraction and/or has an exothermic peak corresponding to the crystallization of the amorphous material as determined by Differential Thermal Analysis.

The term “metal” refers to an opaque, fusible, ductile, and typically lustrous substance that is a good conductor of electricity and heat, forms a cation by loss of electron(s), and yields basic oxides and hydroxides.

The term “plastic” as used herein, refers to any one of rigid organic materials that are typically thermoplastic or thermosetting polymers of high molecular weight and that can be made into objects (e.g., layers or cores).

The terms “polymer” or “polymers” includes homopolymers and copolymers, as well as homopolymers or copolymers that may be formed in a miscible blend, e.g., by coextrusion or by reaction, including, e.g., transesterification. The term “copolymer” includes random, block and star (e.g. dendritic) copolymers.

In this application, the term “machine direction” refers to the direction in which the web (e.g., substrate) travels. Similarly, the term cross-web refers to the direction perpendicular to the machine direction (i.e., perpendicular to the direction of travel for the web), and in the plane of the top surface of the web.

As used in this specification and the appended embodiments, the singular forms “a”, “an”, and “the” include plural referents unless the content clearly dictates otherwise. Thus, for example, reference to layers containing “a metal” includes a mixture of two or more metals. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

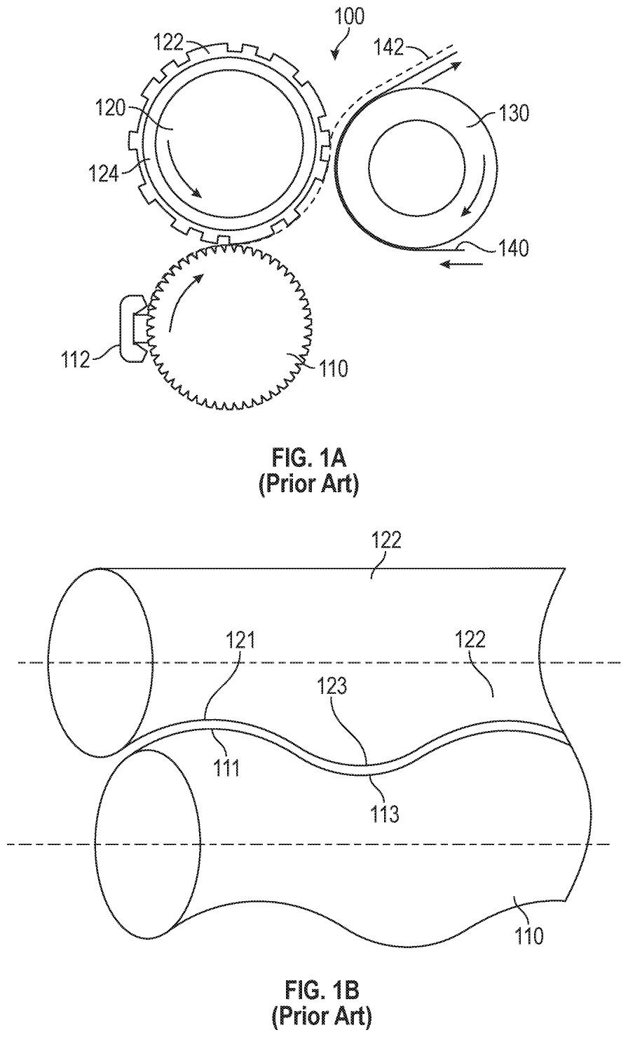

Flexographic printing is a relief-based printing technique that applies discontinuous coatings utilizing raised features on either a flexible polymeric plate or laser engraved rubber as an image carrier. These raised features are typically inked via an anilox roll, which is a continuously engraved roll of precision micro-wells, transferring a specific volume of ink from the wells onto the raised features of the image carrier (i.e. the printing plate). This ink is subsequently transferred from the image carrier onto the substrate. A schematic of a conventional flexographic printing system 100 can be found in FIG. 1A, including a rigid anilox roll 110 with an ink supply 112; a steel plate cylinder 120 with a polymeric plate 122 mounted on a foam flexo tape 124; a rigid steel impression cylinder 130; and a substrate 140 upon which the polymeric plate prints an ink pattern 142.

Further, referring to FIG. 1B, a schematic portion side view of a rigid anilox roll 110 and a deformable flexographic printing plate 122 is provided, in which the shape provided by the anilox roll micro-wells is highly exaggerated. Due to its flexibility, the deformable flexographic printing plate 122 deforms to conform to the shape of the rigid anilox roll 110 in a nip region, to allow transfer of ink from the micro-wells of the rigid anilox roll 110 to the deformable flexographic printing plate 122. For instance, at the location of a raised area 111 of the rigid anilox roll 110, the deformable flexographic printing plate 122 conforms such that an area 121 can contact the raised area 111. Similarly, at the location of a depressed area 113, the deformable flexographic printing plate 122 conforms such that an area 123 can simultaneously contact the depressed area 113.

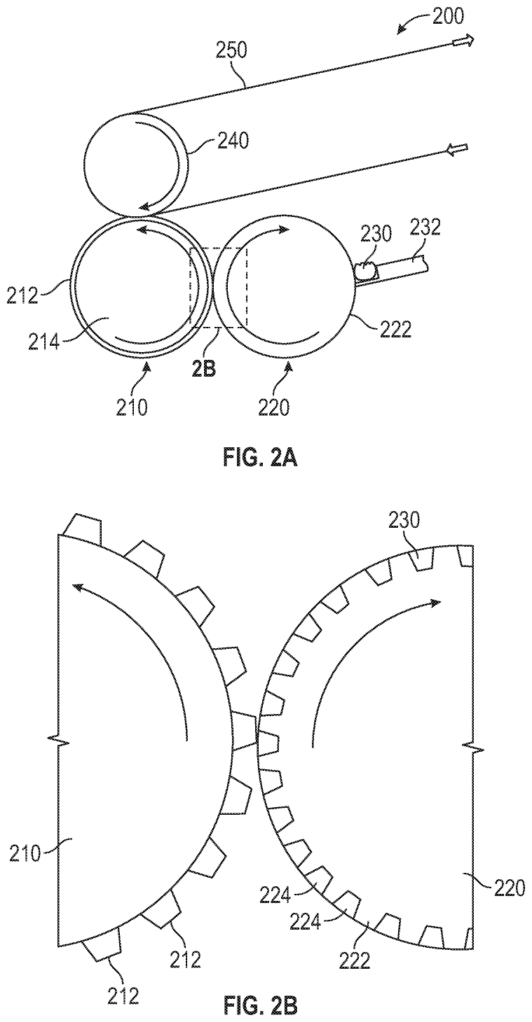

In contrast to a conventional flexographic printing system, a printing system was prepared including both a rigid printing roll and a rigid inking roll. More particularly, referring to FIG. 2A, a schematic cross-sectional view of a comparative printing system 200 is shown. The printing system of FIG. 2A includes a printing roll 210 having a rigid printing pattern 212 on a surface thereof configured to receive an ink material 230; and an inking roll 220 positioned adjacent to the printing roll 210. The inking roll 220 comprises a rigid surface 222 and a plurality of cells (not shown) disposed on the rigid surface 222. This printing system 200 further comprises an applicator 232 configured to coat the ink material 230 onto at least a portion of the rigid surface 222 of the inking roll 220. The embodiment shown in FIG. 2A further comprises a (e.g., rubber) impression roll 240 positioned adjacent to the printing roll 210 to form a nip. The printing system 200 also comprises a substrate 250 provided into the nip, such as for receiving printed ink material onto a surface of the substrate 250.

Referring now to FIG. 2B, an enlarged portion view of the printing system 200 of FIGS. 2A and 2C is shown. The enlarged view shows a portion of the printing roll 210 having a rigid printing pattern 212 on a surface thereof configured to receive an ink material; and a portion of an inking roll 220 positioned adjacent to the printing roll 210. The inking roll 220 comprises a rigid surface 222 and a plurality of cells 224 disposed on the rigid surface 222 containing the ink material 230. In use of the printing system 200, however, the ink material 230 was not successfully transferred from the inking roll 220 to the printing roll 210. This is believed to be because very little contact was made between the two rigid surfaces (i.e., the inking roll rigid surface 222 and the rigid printing pattern 212), despite using a high loading force to press the cylinders against each other, as both the printing roll 210 and inking roll 220 are rigid, and so cannot deflect to account for variations in the diameter of either roll, which may occur in either or both the circumferential and axial directions.

Referring to FIG. 2C, a schematic portion side view is provided of a rigid printing roll 210 and a rigid anilox roll 220, in which the shape provided by the anilox roll micro-wells is highly exaggerated. Due to its rigidity, the rigid printing pattern 212 does not deform to conform to the shape of the rigid anilox roll 220 to allow sufficient transfer of ink material from the micro-wells of the rigid anilox roll 220 to the rigid printing pattern 212 of the rigid printing roll 210. For instance, at the location of a raised area 211 of the rigid anilox roll 220, the rigid printing pattern 212 is able to touch the rigid anilox roll 220 such that an area 221 can contact the raised area 211. In contrast, at the location of a depressed area 213, the rigid printing pattern 212 is too rigid to conform to the shape of the rigid anilox roll 220, such that the area 223 does not contact the depressed area 213.

Moreover, in some embodiments, a roll may not be perfectly cylindrical, with a departure from cylindricity quantified using a total indicated runout (TIR), which can be defined as the difference between the largest and smallest values of the radius on the roll. For example, a roll with a maximum radius of 150.100 mm in one location, and a minimum radius of 150.000 mm in another location, would have a TIR of 0.100 mm.

In practice, the fact that neither the anilox roll not the rigid printing surface are perfectly cylindrical means that a uniform printing pattern cannot be produced with this construction as both the anilox roll and rigid printing surface have high flexural rigidities. Therefore, neither roll can deflect enough to produce uniform contact across the nip region, and thus a uniform printed pattern is not obtained.

It is important to highlight that an anilox roll typically has a liquid layer that is approximately level with the top of the cells, i.e. there is not an excess of liquid above the surface of the cells. This is to be contrasted with offset printing, which typically uses a smooth roll with no engraved cells to apply liquid to the printing plate. In the case of offset printing, so long as the thickness of the liquid layer is greater than the variation in cylindricity of the applicator roll and the printing roll, one might still expect acceptable printing quality. When an anilox roll is used to ink the stamp, however, one of the two rolls (the stamp or the anilox roll) must deform to account for variations in cylindricity of the two rolls.

It is important to highlight that an anilox roll typically has a liquid layer that is approximately level with the top of the cells, i.e. there is not an excess of liquid above the surface of the cells. This is to be contrasted with letterpress printing, which typically uses a smooth applicator roll with no engraved cells to apply liquid to the printing plate. In the case of letterpress printing, so long as the thickness of the liquid layer is greater than the variation in cylindricity of the applicator roll and the printing roll, one might still expect acceptable printing quality. When an anilox roll is used to ink the letterpress stamp surface, however, one of the two rolls (the stamp or the anilox roll) must deform to account for variations in cylindricity of the two rolls.

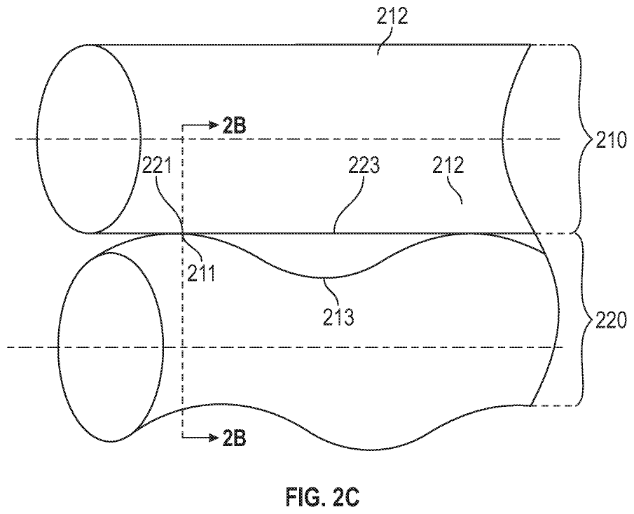

In a first aspect of the present disclosure, a printing system is provided. The printing system comprises a printing roll having a rigid printing pattern on a surface thereof configured to receive an ink material; and an inking roll positioned adjacent to the printing roll. The inking roll comprises an elastically deformable surface and a plurality of cells disposed on the elastically deformable surface. Referring to FIG. 3A, a schematic cross-sectional view of one exemplary printing system 300, for instance to print a pattern on a web in a roll-to-roll process, according to one embodiment of the present disclosure. The printing system of FIG. 3A includes a printing roll 310 having a rigid printing pattern 312 on a surface thereof configured to receive an ink material 330; and an inking roll 320 positioned adjacent to the printing roll 310. The printing roll 310 and the inking roll 320 are rotatably mounted adjacent to each other with the respective axes parallel to each other. The inking roll 320 comprises an elastically deformable surface 322 and a plurality of cells (not shown) disposed on the elastically deformable surface 322. In some embodiments, the printing roll 310 may be formed by two or more rolls (e.g., a primary roll, and a secondary roll) that are coaxially arranged side by side. A first pattern of printing features can be provided on one of the rolls (e.g., the primary roll), and a second pattern of printing features can be provided on another roll (e.g., the secondary roll).

Typically, the printing system 300 further comprises an applicator 332 configured to coat the ink material 330 onto at least a portion of the elastically deformable surface 322 of the inking roll 320. In some embodiments, the ink material 330 may be applied to the surface of the inking roll 320 by the applicator 332 that sprays, brushes, or dispenses the ink material 330 onto a portion of the inking roll 320 while the inking roll 320 axially rotates. In some embodiments, a portion of the inking roll 320 may be submerged in the ink material 330 held in a basin or other reservoir of the applicator 332. In the embodiment of FIG. 3A, the applicator 332 comprises a doctor blade system. It is to be understood that any suitable applicator can be used to apply an ink material with a desired width on the surface of the inking roll 320. Exemplary applicators can be commercially available from Retroflex, Inc. (Wrightstown, Wis.) under a trade designation of Reverse Angle Doctor Blade Systems (RADBS). The ink material 330 can include any suitable ink compositions. Typical ink materials can include, for example, water- or solvent-based flexographic printing ink compositions, 100% solids, UV curable inks or adhesives, etc. Curing can be accomplished by, for example, exposure of the coating to elevated temperature, or actinic radiation. Actinic radiation can be, for example, in the UV spectrum, or include electron-beam radiation.

The embodiment shown in FIG. 3A further comprises an impression roll 340 positioned adjacent to the printing roll 310 to form a nip 360. The impression roll typically comprises an elastomeric material, such as a rubber, a foam, or a combination thereof (e.g., a layer of a foam disposed over/around a layer of a rubber, or vice versa). Suitable elastomeric materials may include thermoset elastomers such as, for example, nitriles, fluoroelastomers, chloroprenes, epichlorohydrins, silicones, urethanes, polyacrylates, EPDM (ethylene propylene diene monomer) rubbers, SBR (styrene-butadiene rubber), butyl rubbers, nylon, polystyrene, polyethylene, polypropylene, polyester, polyurethane, synthetic or natural foams, etc.

The printing system 300 usually further comprises a substrate 350 provided into the nip 360, such as for receiving printed ink material 334 onto a surface 352 of the substrate 350. Suitable substrates can include any suitable flexible substrate, such as, for example, a polymer web, a paper, a polymer-coated paper, a release liner, an adhesive coated web, a metal coated web, a flexible glass or ceramic web, a nonwoven, a fabric, or any combinations thereof. Substrates can be referred to as being of indefinite length, in the machine direction, particularly in roll-to-roll processing of substrates.

Referring now to FIG. 3B, an enlarged portion view of the printing system 300 of FIG. 3A is shown. The enlarged view shows a portion of the printing roll 310 having a rigid printing pattern 312 on a surface thereof configured to receive an ink material 330, and a portion of an inking roll 320 positioned adjacent to the printing roll 310. The inking roll 320 comprises the elastically deformable surface 322 and a plurality of cells 324 disposed on the elastically deformable surface 322 containing the ink material 330. In use of the printing system 300, when the inking roll 320 and the printing roll 310 come into contact, the pressure between the two rolls causes a portion of the elastically deformable surface 322 of the inking roll 320 to elastically deform (e.g., in a direction away from the printing roll 310 at the points of contact), creating a uniform line of contact in the crossweb direction (i.e. in a nip region) between the printing roll 310 and the inking roll 320. This uniform line of contact allows for the transfer of ink material 330 from the plurality of cells 324 to a surface of the rigid printing pattern 312 of the printing roll 310. The extent of deformation is exaggerated for ease of viewing in the figure.

Referring to FIG. 3C, a schematic portion side view is provided of a printing roll 310 having a rigid printing pattern 312 and an inking roll 320 having an elastically deformable surface 322, prior to engagement of the rolls, in which the shape provided by the cells of the inking roll 320 is highly exaggerated. In its original shape, the elastically deformable surface 322 includes at least a raised area 311 and a depressed area 323. Referring now to FIG. 3D, a schematic portion side view is provided of the rolls of FIG. 3C after engagement. Due to its deformability, the elastically deformable surface 322 deforms to conform to the shape of the rigid printing pattern 312 to allow transfer of ink material from the cells of the inking roll 320 to the rigid printing pattern 312. For instance, at the location of an area 321 of the rigid printing pattern 312, the elastically deformable surface 322 conforms such that the originally raised area 311 can contact the area 321. Similarly, at the location of another area 323 of the rigid printing pattern 312, the elastically deformable surface 322 simultaneously conforms such that the originally depressed area 313 can contact the area 323. Surprisingly, the elastically deformable surface 322 is capable of a) holding ink material 330 in its cells 324, b) deforming during contact with the rigid printing pattern 312 of the printing roll 310, c) transferring ink material 330 from the cells 324 to the rigid printing pattern 312, d) elastically returning to its original (e.g., non-deformed) shape, e) receiving additional ink material 330 from the applicator 332, and f) repeating each of a) through e) with each rotation of the inking roll 320.

In any embodiment, the inking roll 320 comprises a shell layer 326 and an elastomeric layer 328, wherein the shell layer 326 is disposed around the elastomeric layer 328. In certain embodiments, the inking roll 320 additionally comprises a core 329, wherein the elastomeric layer 328 is disposed around the core 329. The optional core may be formed of a rigid material (e.g., metal or plastic, for instance a metal core, a fiberglass core, a fiberglass shell mounted on a metal core, etc.). In some embodiments, the core of the inking roll comprises stainless steel, aluminum, a carbon fiber reinforced polymer (CFRP), chrome or nickel plated multilayer steel-copper-steel, epoxy resin, or vinyl-ester epoxy resin.

In many embodiments, the rigid printing pattern is formed on a surface of the outer layer of the printing roll. The outer layer is often composed of nickel, stainless steel, copper, chrome, alloys, or any combination thereof. In select embodiments, the outer layer comprises two or more directly adjacent layers of metal, for example chrome-plated copper. Additional suitable materials for the outer layer include for instance and without limitation chromium oxide ceramic, as well as a ceramic coated on any one of the following materials: steel, carbon fiber reinforced polymer (CFRP), glass fiber reinforced polymer (GFRP), aluminum, or copper (e.g., ceramic coated steel, ceramic coated CFRP, ceramic coated GFRP, ceramic coated aluminum, or ceramic coated copper). The ceramic coating may include at least one glass, crystalline ceramic, or glass-ceramic material. In some embodiments, the core of the printing roll comprises stainless steel, aluminum, a carbon fiber reinforced polymer (CFRP), chrome or nickel plated multilayer steel-copper-steel, epoxy resin, or vinyl-ester epoxy resin.

Outer layer of the printing roll can have different flexural stiffness, depending on material used for the outer layer and thickness of the outer layer. Ranges of flexural stiffness of an outer printing layer might include 0.01 Pa·m³ or greater, 0.05 Pa·m³ or greater, 0.1 Pa·m³ or greater, 0.2 Pa·m³ or greater, 0.5 Pa·m³ or greater, 0.75 Pa·m³ or greater, 1 Pa·m³ or greater, 2 Pa·m³ or greater, 3 Pa·m³ or greater, 5 Pa·m³ or greater, 7 Pa·m³ or greater, or 10 Pa·m³ or greater; and 100 Pa·m³ or less, 75 Pa·m³ or less, 50 Pa·m³ or less, 35 Pa·m³ or less, 25 Pa·m³ or less, 15 Pa·m³ or less, 10 Pa·m³ or less, 8 Pa·m³ or less, 6 Pa·m³ or less, 4 Pa·m³ or less, 2 Pa·m³ or less, 1 Pa·m³ or less, 0.1 Pa·m³ or less, or 0.05 Pa·m³ or less. Stated another way, ranges of flexural stiffness of an outer printing layer might include 0.01 Pa·m³ to 0.05 Pa·m³, 0.01 Pa·m³ to 0.1 Pa·m³, 0.05 Pa·m³ to 1 Pa·m³, 0.1 Pa·m³ to 10 Pa·m³, and 0.2 Pa·m³ to 100 Pa·m³.

The desired printing features of the rigid printing pattern may be obtained e.g., by engraving, knurling, diamond turning, laser ablation, electroplating or electroless deposition, photolithography, etching, or the like, as will be familiar to those of skill in the art. It may be convenient to provide the features of the printing pattern by micromachining, e.g., by diamond turning. For example, a printing roll (e.g., outer layer) can be provided comprising a machinable rigid printing surface (e.g., steel). The printing surface can be machined to leave behind protrusions (for example, ridges) that are the pattern that is desired to be printed (e.g., on a substrate). If features such as gaps, notches, etc. are desired to be provided, the surface of the printing roll can be manipulated, for instance as the machining tool traverses across the previously formed ridges of the printing surface. Such manipulations may be performed e.g., with a machining tool that is controlled by a fast tool servo, such as described in U.S. Pat. No. 7,677,146 (Gardiner et al.).

In some embodiments, the pattern features can be surface-treated to control the amount of ink material that can be transferred to the pattern features. For example, a hydrophilic coating can be provided on the pattern features to enhance the ink wet-out on the pattern features.

The pattern of the rigid printing pattern is not particularly limited. Advantageously, printing rolls according to at least certain embodiments of the present disclosure can have small printing features to achieve high printing resolution of small features. In such embodiments, the rigid printing pattern may include pattern features having a width of up to 20 micrometers at a printing contact point, 18 micrometers or less, 15 micrometers, 12 micrometers, 10 micrometers, 8 micrometers, or 6 micrometers or less at a printing contact point; and 1 micrometer or more, 2 micrometers, or 3 micrometers or more at a printing contact point. Stated another way, the rigid printing pattern may include pattern features having a width of 1 to 5 micrometers, inclusive. Optionally, the rigid printing pattern may have a density of pattern features of up to 100%, up to 99%, 98%, 95%, 90%, or up to 85%. A manufacturer of a suitable exemplary printing roll is Flexible Cutting Systems (St. Louis, Mo.).

In contrast to a high density pattern, in some embodiments the rigid printing pattern may have a pattern feature coverage of the total area of the rigid printing pattern of 10% or less, 8% or less, 6% or less, or 1% to 5%. The use of a rigid material for the rigid printing pattern advantageously minimizes the problem of stamp collapse, in which a printing roll having pattern features separated by a large open area exhibit collapse of a portion of the open area between the distant pattern features due to the flexibility of the printing roll surface.

In traditional relief printing operations, a printing roll is pressed against a film surface while the film is wrapped against a back-up roll. Relief printing plates may have a thickness of about 0.1 mm, 0.2 mm, 0.5 mm, 0.7 mm, or 1 mm. Typically, the relief printing plate is attached to a printing roll with a mounting tape. An example of a mounting tape is the 3M Cushion-Mount product, which may have an elastic modulus of about 1.5 MPa (though this may range from between about 0.1 MPa to 10 MPa), and a typical thickness of about 1 mm (though this may range from between about 0.1 to 1.5 mm). When printing, the printing roll is engaged against a surface of a film, generating a footprint w, which may have a characteristic with of about 0.1 mm. 0.5 mm, 1 mm, 2 mm, or 5 mm. During this engagement, a force per unit width P develops in the foam layer that can be estimated using the equation E_foam*(w³)*((1−v)²)/(24(1−v²)([24)1−2v)*Reff*t_foam], where v is Poisson's ratio, and Reff is the effective radius of the printing roll and the back-up roll (i.e., 1/Reff=1/R_{printing roll}+1/R_{back-up roll}) (Contact Mechanics; K. L. Johnson; Cambridge University Press 1985). During printing, the printing features on a flexographic printing plate are pressed against a surface of the anilox roll and subsequently to a substrate, while the areas in between adjacent printing features of the printing plate (known as the stamp floor) ideally do not contact either the substrate or the anilox roll. The typical height of the printing features are about 0.5 mm, but may be 0.4 mm, 0.3 mm, 0.25 mm, 0.1 mm, or 0.05 mm depending on the target resolution and method for making a printing plate, and on the spacing between adjacent features. When the deflection Y (defined above) is greater than the height of a printing feature, the stamp floor may touch the surface of the anilox roll and/or the substrate, depositing ink in undesirable locations—a phenomena is known as stamp collapse. As the deflection Y is proportional to the fourth power of the distance between printing features, stamp collapse may be more likely to occur when printing features are separated by a large distance. That distance can be 1 mm, 5 mm, 1 cm, 5 cm, 10 cm, 20 cm, 50 cm, or 1 m depending on the height of the printing features.

To avoid stamp collapse, a printing plate must have a high flexural stiffness. High flexural stiffness can be achieved by increasing either the elastic modulus or the thickness of the printing plate. Although increasing the flexural stiffness of a printing plate may be a reasonable way to avoid stamp collapse, such a stamp may lose the ability to conform to the anilox roll as neither the printing roll nor the anilox roll are perfectly cylindrical in a traditional flexographic printing system, and a stamp with a high flexural stiffness may not be able to conform to the imperfections in either roll. This leads to poor ink transfer from the anilox roll to the printing plate, and subsequently poor print quality. By using a deformable anilox roll construction, this invention enables the use of printing plates with high flexural rigidities, avoiding stamp collapse, but at the same time enabling uniform ink transfer from anilox roll to printing features of the printing plate.

The elastic modulus of a rigid material may be important in designing a printing roll according to the present disclosure. As indicated above, the “elastic modulus” is the ratio of the stress-to-strain for the straight-line portion of the stress-strain curve, which may be obtained by applying an axial load to a test specimen and measuring the load and deformation simultaneously. A test specimen is usually loaded uniaxially and the load and strain are measured, either incrementally or continuously. The elastic modulus for materials employed in the present disclosure may be obtained using a standardized ASTM test. The ASTM tests employed for determining elastic (or Young's) modulus are defined by the type or class of material that is to be analyzed under standard conditions. A general test for structural materials, including metals, is covered by ASTM E111-17 and may be employed for structural materials in which creep is negligible, compared to the strain produced immediately upon loading and to elastic behavior. The standard test method for determining tensile properties of plastics is described in ASTM D638-14 and may be employed when evaluating unreinforced and reinforced plastics (e.g., composites). If a vulcanized thermoset rubber or thermoplastic elastomer is selected for use, then standard test method ASTM D412-16, which covers procedures used to evaluate the tensile properties of these materials, may be employed. If a glass or glass-ceramic material is employed, then standard test method ASTM C623-92(2015) may be employed.

It is important to realize that modulus values convey intrinsic material properties and not precisely-comparable composition properties. This is especially true when dissimilar classes of materials are employed in different layers. When this happens, it is the value of the modulus for each layer that is important, even though the test methods may not be directly comparable. When materials of the same class are employed in an outer layer then, if possible, a common test method may be employed to evaluate the modulus of the materials. And if different classes of materials are employed in a single outer layer, then the skilled artisan will need to select the test that is most appropriate for the combination of materials. For example, if an outer layer contains a ceramic powder in a polymer, the ASTM test for plastics would probably be the more suitable test method if the plastic portion was the continuous phase in the layer.

When evaluating properties such as stiffness, elastic modulus, and flexural modulus, it generally will not be possible to evaluate these parameters for the outer layer while a part of the printing roll itself. The evaluator will need to ascertain the composition of a layer, and test that composition for stiffness and modulus. The relative stiffness of a layer can be arrived at by reproducing a layer of material in a size and form factor appropriate for the chosen test method, and supporting it horizontally at one end. Another layer of material of the same size and construction is supported the same way. The amount of deflection of each layer is measured. When evaluating modulus, an appropriate test method is selected, which test method allows the stress-to-strain ratio to be determined for the straight-line portion of the stress-strain curve.

A typical anilox inking roll may include a hard cylinder, usually constructed of a steel or aluminum core which is coated by an industrial ceramic. In embodiments of the present disclosure, in contrast, the inking roll may comprise a shell layer and an elastomeric layer (as noted above). The shell layer often comprises a thickness of 1.27 centimeters (cm) or less, 1.20 cm, 1.15 cm, 1.10 cm, 1.05 cm, 1.00 cm, 0.95 cm, 0.90 cm, or 0.85 cm or less, and 0.20 cm or more. The thickness is selected to allow elastic deformation of the shell at typical loads caused during a printing process. It can also be useful to pair a shell thickness with a suitable modulus of the elastomeric material. For instance, in select embodiments, the shell layer comprises a thickness of 0.127 cm or less and the elastomeric layer exhibits a modulus of 10 MPa or less. The shell layer is much thinner as compared to the diameter of the inking roll. In some embodiments, the ratio between the thickness of the shell layer and the diameter of the inking roll may be, for example, no greater than 1:20, no greater than 1:50, no greater than 1:80, no greater than 1:100, no greater than 1:200, or no greater than 1:500. In some embodiments, a thickness ratio between the elastomeric layer and the shell layer can be about 3:1 or greater, about 5:1 or greater, about 7:1 or greater, about 10:1 or greater, about 15:1 or greater, about 20:1 or greater, or about 25:1 or greater.

The shell layer is often composed of ceramic, metal, plastic, or rubber. In some embodiments, the shell layer comprises chromium oxide ceramic, steel, a carbon fiber reinforced polymer (CFRP), a glass fiber reinforced polymer (GFRP), aluminum, ceramic coated copper, or chrome plated copper. In select embodiments, the shell layer is composed of nickel, stainless steel, copper, chrome, alloys, or any combination thereof. In some embodiments, the hardness of the shell layer can be described by Mohs hardness, and have a Mohs hardness of 3 or greater, 4 or greater, 5 or greater, 6 or greater, 7 or greater, 8 or greater, 9 or greater, or up to 10. In some embodiments, a range of Mohs hardness of a shell layer is between 3 and 10 or between 5 and 10. In some embodiments, the shell layer can be made of one or more materials that are substantially incompressible, e.g., the relative volume change of the material in response to a contact pressure is less than 5%, less than 2%, less than 1%, less than 0.5%, or less than 0.2%.

The elastomeric layer conveniently has a hardness that deforms to a certain extent, but does not allow the shell layer to deform beyond its elastic limit by the pressure from the rigid printing pattern. To achieve these criteria, the elastomeric layer may conveniently include elastic materials such as, for example, a rubber with a hardness within an appropriate range, for example, no less than 10, 20, 30, 40, or 50 Shore A, and no greater than 90, 85, 80, or 75 Shore A. In some embodiments, it may be more appropriate to use the Shore OO scale to measure the hardness of the elastomeric layer within an appropriate range, for example no less than 10, 20, 30, 40, or 50 Shore OO, and no greater than 90, 85, 80, or 75 Shore OO. In some embodiments, the elastomeric layer can include one or more materials of a rubber or a foam.

A suitable foam can be open-celled or closed-celled, including, for example, synthetic or natural foams. In some embodiments, the foam may comprise a polyurethane foam, a polyester foam, a polyether foam, a filled or grafted polyether foam, a melamine foam, a polyethylene foam, a cross-linked polyethylene foam, a polypropylene foam, a silicone foam, or an ionomeric foam.

In some embodiments, the elastomeric layer may be compressible and capable of preventing slip between the (e.g., thin) shell layer and the elastomeric layer. The elastomeric layer is configured to be elastically deformable, e.g., being capable of substantially 100% (e.g., 99% or more, 99.5% or more, or 99.9% or more) recovering to its original state after being deformed. In some embodiments, the elastomeric layer can be compressible to provide the desired deformability. A suitable compressible elastomeric layer may be made of a foam. The elastomeric layer usually has a higher compressibility than the shell layer. In some embodiments, the elastomeric layer can have a Poisson's ratio less than about 0.5, less than about 0.4, less than about 0.3, or preferably less than about 0.2. In some embodiments, the elastomeric layer can have a negative Poisson's ratio. In contrast, in some embodiments, the shell layer can have a Poisson's ratio greater than about 0.1, greater than about 0.2, greater than about 0.3, or preferably greater than about 0.4.

In some embodiments, the elastomeric layer may be substantially incompressible, but sufficiently soft to provide the desired deformability. In some embodiments, the elastomeric layer may be a layer made of substantially incompressible material which has been patterned, embossed, or engraved to provide the desired deformability, e.g., to effectively be compressible. The patterned elastomer may have patterned structures (e.g., engraved surface structures) located on the outer surface of the elastomeric layer that contacts to the shell layer. The patterned structure may be formed by imparting onto the surface of the elastomeric layer using any suitable techniques including, for example, engraving, ablating, molding, etc., to provide desired Poisson's ratio, compressibility, and elastic response.

Further, in some embodiments the elastomeric layer is mounted on a (e.g., rigid) central core (e.g., a metal core, a fiberglass core, a fiberglass shell mounted on a metal core, etc.) with a substantially uniform thickness about the periphery of the central core.

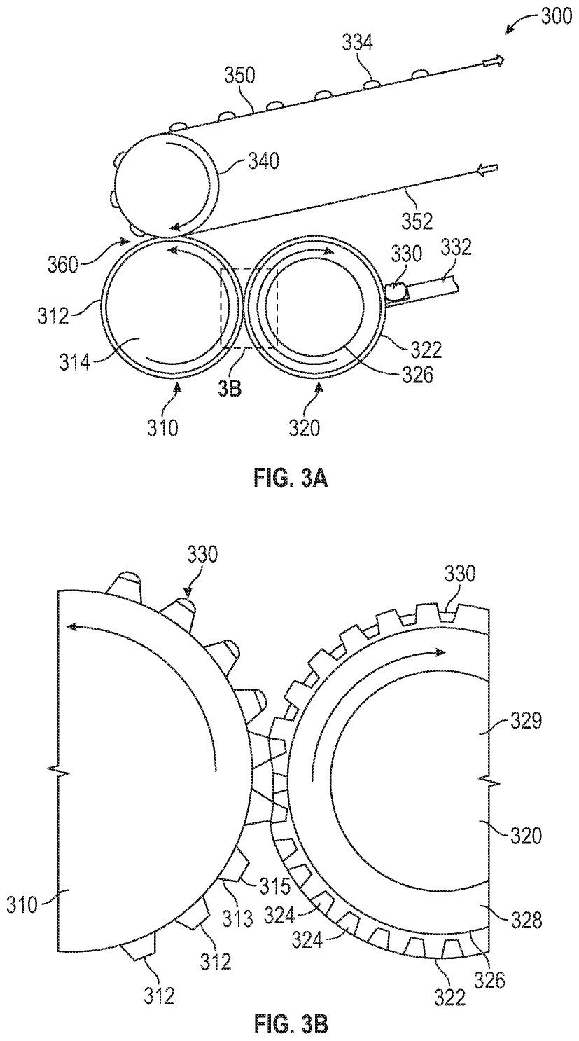

Referring now to FIG. 4A, in some embodiments, the plurality of cells 424 is integral to the shell layer 426 of the inking roll 420. In this case, the plurality of cells 424 are formed of the same material as the elastically deformable surface 422, and both are a part of the shell layer 426. In contrast, referring to FIG. 4B, in some embodiments, the plurality of cells 424 is formed on a layer 427 that is directly adjacent to the shell layer 426 of the inking roll 420 and the elastically deformable surface 422 is integral to the shell layer 426. Alternatively, referring to FIG. 4C, in some embodiments, one more additional layers 425 (e.g., a tie layer) are disposed between the layer 427 having the plurality of cells 424 and the shell layer 426 of the inking roll 420 having the elastically deformable surface 422. The plurality of cells 424 should be in sufficiently close proximity to the elastically deformable surface 422 to be capable of transferring ink material to a printing roll. Also shown in FIGS. 4A-4C is an elastomeric layer 428 disposed directly adjacent to the shell layer 426, opposite the elastically deformable surface 422. Typically, a suitable elastomeric layer exhibits a modulus of 0.1 to 100 megapascals (MPa) or 0.1 MPa to 25 MPa. In any embodiment, the plurality of cells may further comprise a coating (not shown) conformal to the plurality of cells, such as a coating of chrome or other material that imparts at least one desirable property to the cells (e.g., abrasion resistance, rigidity, etc.). Such a coating may have a thickness of about 0.5 to 3 micrometers.

The plurality of cells may be formed of various shapes, for instance fine dimples or grooves, to receive an ink material. Suitable ink metering systems can be applied to dispose ink material into the plurality of cells. For example, a self-contained system such as a chambered doctor blade system can be used, which includes a manifold to deliver ink material to the inking roll and remove excess ink, leaving just the measured amount of ink in the cells. The plurality of cells (e.g., on the reversibly deformable surface) may each have a volume factor of 0.3 billion cubic microns per square inch (bcm) or greater, 0.5 bcm, 0.75 bcm, 0.9 bcm, 1 bcm, 2 bcm, 5 bcm, 7 bcm, 10 bcm, 12 bcm, 15 bcm, or 20 bcm or greater; and a volume factor of 100 bcm or less, 90 bcm, 80 bcm, 75 bcm, 70 bcm, 60 bcm, 50 bcm, or 40 bcm or less. Stated another way, each of the cells may have a volume factor of 0.3 to 100 bcm, or 0.3 to 40 bcm. The inking roll 420 may additionally have adjacent areas with cells engraved at different volumes—e.g., a portion of the surface of the roll may be engraved at 1 bcm, another portion at 2 bcm, yet another portion at 2.3 bcm, and so on. These areas may be separated by unengraved areas that are effectively smooth (i.e., do not contain any purposely engraved cells). There are typically not any restrictions on the number, size or relative orientations of these areas.

The ink material can include any suitable ink compositions which can be dried, cured, or solidified to form a dried ink pattern. Exemplary ink materials can be commercially available from Nazdar Company (Shawnee, Kans.) under the trade designation of Nazdar 9400 Series UV Flexo Ink and from Flint Group Company (Luxembourg) under the trade designation of Flint Group HMC 80080 UV ink.

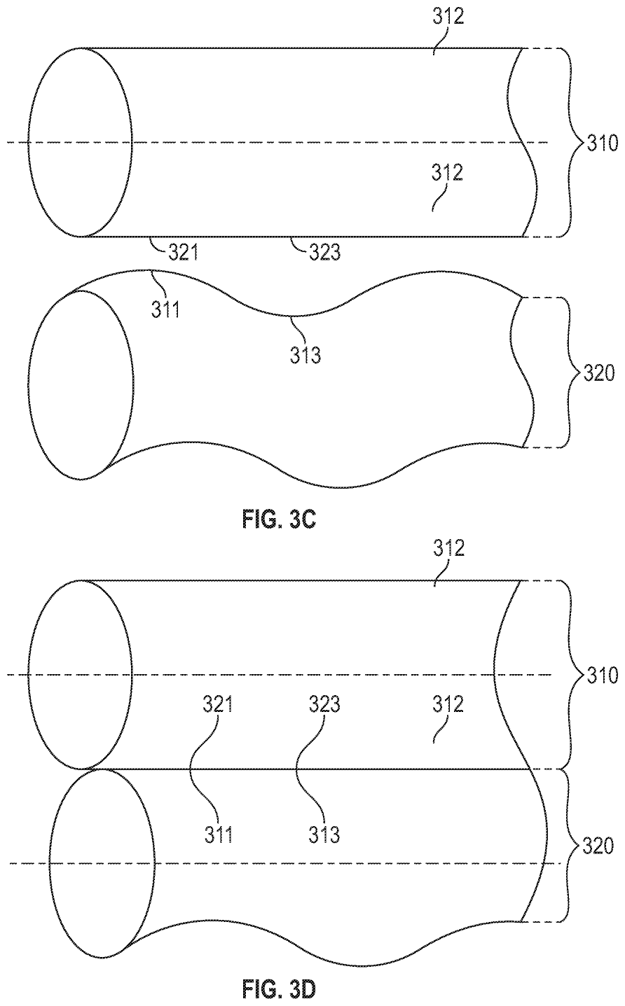

Referring to FIG. 5, it is to be understood that the shape of the elastically deformable surface 522 of the inking roll 520 deforms, and that the material of the elastically deformable surface 522 may be substantially incompressible, such that when the elastically deformable surface 522 is in contact with the printing roll (not shown), a portion of the elastically deformable surface 522 is deformed in one direction (e.g., to an engagement depth “D”), at least one other portion of the elastically deformable surface 522 is deformed in the opposite direction (e.g., to an opposing depth “OD”). The opposing depth “OD” is typically smaller than the engagement depth “D” because a larger area of the elastically deformable surface 522 is available to deform in the opposing direction than the area of the elastically deformable surface 522 that deforms in the engagement direction. The dotted line 522′ indicates the original, non-deformed shape of the elastically deformable surface 522.

In some embodiments, the inking roll 520 exhibits a circumferential length of elastic deformation “L” of the elastically deformable surface 522 upon contact with the printing roll (not shown). The length of elastic deformation is 10 micrometers or greater, 25 micrometers or greater, 50 micrometers or greater, 55 micrometers, 60 micrometers, 70 micrometers, 75 micrometers, 80 micrometers, 90 micrometers, 100 micrometers, 110 micrometers, 125 micrometers, 135 micrometers, or 150 micrometers or greater; and 1 millimeter or less, 500 micrometers or less, 450 micrometers, 400 micrometers, 350 micrometers, 300 micrometers, 250 micrometers, or 200 micrometers or less. Typically, the length L of elastic deformation is a function of the load, e.g., the pressure formed by the positioning of the inking roll and the printing roll with respect to each other.

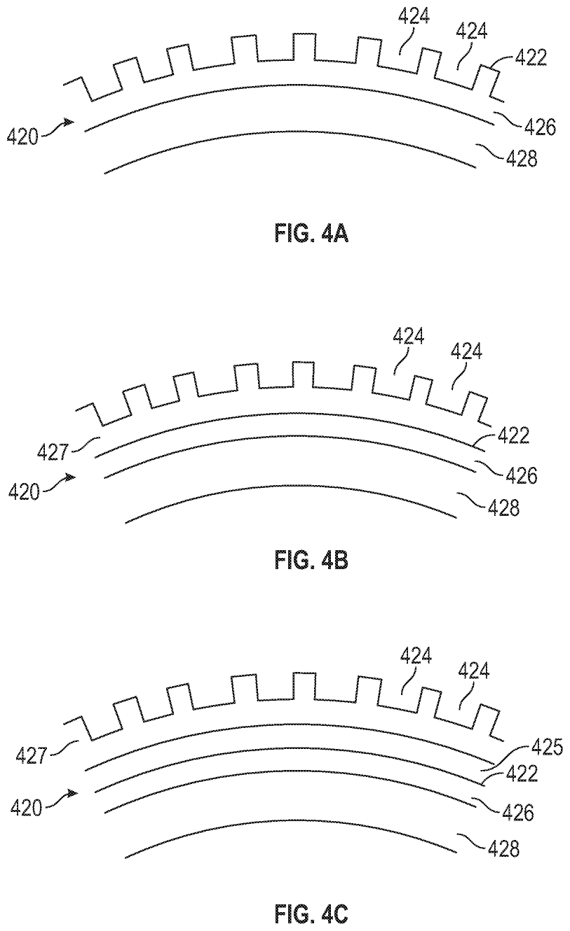

Referring to FIG. 6, the rigid printing pattern 612 is pressed against the inking roll 620 such that the printing features of the printing roll 610 at least partially surpass the un-deformed surface of the elastically deformable surface 622 of the inking roll 620. As shown in FIG. 6, the printing roll 610 is pressed against the inking roll 620 to form an ink material transfer zone, where the rigid printing pattern 612 at a contacting area is impressed into the elastically deformable surface 622 of the inking roll 620 with a length of elastic deformation along the machine direction and an engagement depth D. This is due to the pressure that builds between the rigid printing pattern 612 and the inking roll 620 surface such that the elastically deformable surface 622 deflects to the engagement depth D in the contacting area. In the embodiment shown in FIG. 6, force F is applied from the printing roll 610 towards the inking roll 620 as well as being applied from the inking roll 620 towards the printing roll 610, as a result of the positioning of each of the two rolls.

In some embodiments, the engagement depth D can be within a range, for example, from about 0.001 mm to about 10 mm, from about 0.05 mm to about 5 mm, or from about 0.1 mm to about 1 mm. It is to be understood that the contacting area may not be limited to the area or space between the printing roll and the inking roll (i.e., there may be some distance after the printing roll in the machine direction before which the inking roll recovers to its original shape, plus, an area of the inking roll may deform in an opposing direction as shown in FIG. 5). A contacting area might refer to an area where the surface of the inking roll is deformed in any direction upon the engagement with the printing roll. It also should be noted that the contacting area may not be uniform in the crossweb direction if the printing pattern is not uniform in the crossweb direction, for instance if there are different regions with printed areas separated by a gap.

In some embodiments, the engagement depth D between the printing roll and the inking roll can be adjusted. The engagement depth D can be adjusted to be within a range, for example, from about 0.001 mm to about 10 mm, from about 0.05 mm to about 10 mm, or from about 0.1 mm to about 5 mm. In some embodiments, the engagement depth D can be adjusted by positioning the printing roll and/or the inking roll. The relative position of the printing roll and the inking roll can be adjusted using a mounting and positioning mechanism. The engagement depth D can be adjusted by positioning the printing roll and/or the inking roll such that the rigid printing features of the printing roll intersect the curved plane defined by the elastically deformable surface of the inking roll in its un-deformed state. In some embodiments, the elastic recovery may occur within the time required for an inking roll to make one rotation around its longitudinal axis. In other embodiments, the inking roll partially elastically recovers in the time that the inking roll makes one rotation around its longitudinal axis, for instance exhibits 70% recovery or more of the engagement depth D, 75% recovery or more, 80% recovery or more, 85% recovery or more, 90% recovery or more, 95% recovery or more, 98% recovery or more, or 99% recovery or more, of the engagement depth D, in the time that the inking roll makes one rotation around its longitudinal axis.

In a second aspect, a method of printing is provided. The method includes (a) inking at least a portion of a rigid printing pattern on a surface of a printing roll by contacting the rigid printing pattern with an inking roll; and (b) contacting the rigid printing pattern with a substrate, transferring the ink material from the rigid printing pattern to a surface of the substrate. The inking roll includes an elastically deformable surface and a plurality of cells disposed on the elastically deformable surface. Typically, the method further comprises transferring the ink material to at least a portion of the plurality of cells of the inking roll using an applicator. The applicator sprays, brushes, or dispenses the ink material onto a portion of the plurality of cells of the inking roll while the inking roll axially rotates. Suitable applicators include any means of applying an ink to the anilox roll, for instance a fountain roll or a coating pan with a doctor blade. The method further optionally comprises solidifying the ink material to form a printing pattern on the substrate. The ink material can include any suitable ink compositions which can be dried, cured, or solidified, as noted above. The method is often a roll-to-roll process.

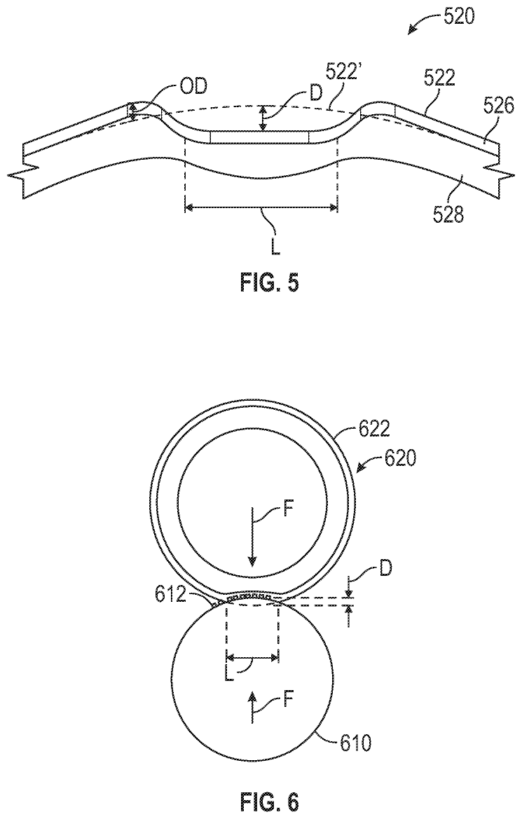

FIG. 7 illustrates a flow diagram of a method of printing an ink pattern, according to one embodiment. The method can be implemented by various apparatuses or systems shown in FIGS. 3A-3B and 6. At 710, the method includes inking at least a portion of a rigid printing pattern on a surface of a printing roll by contacting the rigid printing pattern with an inking roll. In some embodiments, the ink material can be coated onto a surface of the inking roll via an applicator.

The method then proceeds to 720. At 720, the method includes contacting the rigid printing pattern with a substrate, transferring the ink material from the rigid printing pattern to a surface of the substrate. In some embodiments, the ink material can be solidified to form a printing pattern on the substrate, for instance by heat or radiation.

Typically, contacting the rigid printing pattern with a substrate further comprises providing an impression roll positioned adjacent to the printing roll to form a nip, and providing the substrate into the nip. In some embodiments, the impression roll comprises an elastomeric material, such as a rubber, a foam, or a combination thereof, whereas in other embodiments the impression roll comprises a rigid material (e.g., a metal).

Referring again to FIGS. 3A-3B, when the printing system 300 is in use, according to some embodiments of the present disclosure, the printing roll 310 and the inking roll 320 are positioned such that features of the rigid printing pattern 312 can be rotatably impressed into the surface of the inking roll 320. The elastically deformable surface 322 of the inking roll 320 can deflect in unison with the elastomeric layer 328 such that the shell layer 326 is elastically deformed when in contact with the rigid printing pattern 312. The ink material 330 can be transferred from the plurality of cells 324 to the rigid printing pattern 312 upon the contact. As shown in FIG. 3B, the pattern features attached to the printing roll 310 each include a printing surface 315 and a plurality of sides 313. The ink material 330 transferred from the inking roll 320 is disposed at least on the printing surfaces 315 of the rigid printing pattern 312.

The printing roll 310 having the inked rigid printing pattern 312 can rotate to print a pattern on a substrate surface 352 such that when the engaged rigid printing pattern 312 withdraws from the substrate surface, at least some of the ink is retained on the substrate surface 352 to form an ink pattern thereon. The printing roll 310 typically rotates into printing engagement with an impression roll 340 positioned adjacent to the printing roll 310. The printing roll 310 and the impression roll 340 are rotatably mounted adjacent to each other with the respective axes parallel to each other along a cross-web or lateral direction to form a web path to convey a substrate 350. A nip 360 is formed between the printing roll 310 and the impression roll 340, and the substrate 350 is provided into the nip 360.

In some embodiments, the substrate 350 may include a flexible or stretchable material, such as a flexible polymeric web. The substrate 350 is conveyed along its longitudinal direction (i.e., a machine direction, or a down-web direction) into the nip 360. When the substrate 350 is disposed between a surface of the printing roll 310 and a surface of the impression roll 340, the rigid printing pattern 312 of the printing roll 310 transfers ink material 330 to the substrate surface 352 to form an ink pattern 334 thereon. The ink pattern 334 is typically then dried and/or cured.

In some embodiments, the ink material 330 can include a photo initiator, and the ink pattern 334 can be cured by radiation such as, for example, a UV light. In some embodiments, the ink material 330 can include a thermal initiator, and the ink pattern 334 can be cured by heat. In some embodiments, the ink material 330 can be dried by removing solvent or water therefrom.

The operation of the present disclosure will be further described with regard to the following embodiments directed to printing systems and methods. These embodiments are offered to further illustrate the various specific and preferred embodiments and techniques. It should be understood, however, that many variations and modifications may be made while remaining within the scope of the present disclosure.

Embodiment 1 is a printing system. The printing system includes a printing roll having a rigid printing pattern on a surface thereof configured to receive an ink material; and an inking roll positioned adjacent to the printing roll. The inking roll includes an elastically deformable surface and a plurality of cells disposed on the elastically deformable surface.

Embodiment 2 is the printing system of embodiment 1, further including an applicator configured to coat the ink material onto at least a portion of the elastically deformable surface of the inking roll.

Embodiment 3 is the printing system of embodiment 1 or embodiment 2, wherein the inking roll includes a shell layer and an elastomeric layer, wherein the shell layer is disposed around the elastomeric layer.

Embodiment 4 is the printing system of embodiment 3, wherein the elastomeric layer exhibits a modulus of 0.1 to 100 megapascals (MPa) or 0.1 MPa to 25 MPa.

Embodiment 5 is the printing system of embodiment 3, wherein the shell layer has a thickness of 1.27 centimeters (cm) or less or 1.00 cm or less.

Embodiment 6 is the printing system of embodiment 3, wherein the shell layer has a thickness of 0.127 cm or less and the elastomeric layer exhibits a modulus of 10 MPa or less.

Embodiment 7 is the printing system of any of embodiments 3 to 6, wherein the shell layer is composed of ceramic, metal, plastic, or rubber.

Embodiment 8 is the printing system of any of embodiments 3 to 7, wherein the shell layer includes chromium oxide ceramic, steel, a carbon fiber reinforced polymer (CFRP), a glass fiber reinforced polymer (GFRP), aluminum, ceramic coated copper, or chrome plated copper.

Embodiment 9 is the printing system of any of embodiments 3 to 7, wherein the shell layer is composed of nickel, stainless steel, copper, chrome, alloys, or a combination thereof.

Embodiment 10 is the printing system of any of embodiments 1 to 9, wherein the plurality of cells on the reversibly deformable surface each have a volume factor of 0.3 to 100 billion cubic microns per square inch (bcm) or 0.3 to 40 bcm.

Embodiment 11 is the printing system of any of embodiments 3 to 9, wherein the elastomeric layer includes a rubber or a foam.

Embodiment 12 is the printing system of embodiment 11, wherein the foam includes a polyurethane foam, a polyester foam, a polyether foam, a filled or grafted polyether foam, a melamine foam, a polyethylene foam, a cross-linked polyethylene foam, a polypropylene foam, a silicone foam, or an ionomeric foam.

Embodiment 13 is the printing system of embodiment 12, wherein the rubber has a hardness in a range of 20 Shore A or greater to 90 Shore A or less.

Embodiment 14 is the printing system of any of embodiments 1 to 13, wherein the inking roll exhibits a length of elastic deformation of the elastically deformable surface upon contact with the printing roll.

Embodiment 15 is the printing system of embodiment 14, wherein the length of elastic deformation is 50 micrometers or greater or 125 micrometers or greater.

Embodiment 16 is the printing system of any of embodiments 1 to 15, wherein the printing roll includes an outer layer disposed around a core.

Embodiment 17 is the printing system of embodiment 16, wherein the core includes a plastic or a metal.

Embodiment 18 is the printing system of embodiment 16 or embodiment 17, wherein the core includes stainless steel, aluminum, a carbon fiber reinforced polymer (CFRP), chrome or nickel plated multilayer steel-copper-steel, epoxy resin, or vinyl-ester epoxy resin.

Embodiment 19 is the printing system of any of embodiments 16 to 18, wherein the rigid printing pattern is formed on a surface of the outer layer.

Embodiment 20 is the printing system of any of embodiments 16 to 19, wherein the outer layer is composed of nickel, stainless steel, copper, chrome, alloys, or a combination thereof.

Embodiment 21 is the printing system of any of embodiments 16 to 20, wherein the outer layer includes two or more directly adjacent layers of metal.

Embodiment 22 is the printing system of any of embodiments 16 to 21, wherein the outer layer includes chromium oxide ceramic, or ceramic coated on any one of the following: steel, carbon fiber reinforced polymer (CFRP), glass fiber reinforced polymer (GFRP), aluminum, or copper.

Embodiment 23 is the printing system of any of embodiments 1 to 22, further including an impression roll positioned adjacent to the printing roll to form a nip.

Embodiment 24 is the printing system of embodiment 23, wherein the impression roll includes an elastomeric material.

Embodiment 25 is the printing system of embodiment 22 or 23, wherein the impression roll includes a rubber, a foam, or a combination thereof.

Embodiment 26 is the printing system of any of embodiments 1 to 25, further including a substrate provided into the nip.

Embodiment 27 is the printing system of any of embodiments 1 to 26, wherein the rigid printing pattern has a density of pattern features of up to 100% or up to 99%.

Embodiment 28 is the printing system of any of embodiments 1 to 27, wherein the rigid printing pattern includes pattern features having a width of 1 to 5 micrometers at a printing contact point.

Embodiment 29 is the printing system of any of embodiments 1 to 28, wherein the rigid printing pattern has a longitudinal gap between two pattern features of at least 5 centimeters and wherein the two pattern features each have a height of 0.1 millimeters or more at a printing contact point.

Embodiment 30 is the printing system of any of embodiments 1 to 29, wherein the rigid printing pattern has a pattern feature coverage of the total area of the rigid printing pattern of 1% to 5%.

Embodiment 31 is a method of printing. The method includes (a) inking at least a portion of a rigid printing pattern on a surface of a printing roll by contacting the rigid printing pattern with an inking roll; and (b) contacting the rigid printing pattern with a substrate, transferring the ink material from the rigid printing pattern to a surface of the substrate. The inking roll includes an elastically deformable surface and a plurality of cells disposed on the elastically deformable surface.

Embodiment 32 is the method of embodiment 31, further including transferring the ink material to at least a portion of the plurality of cells of the inking roll using an applicator.

Embodiment 33 is the method of embodiment 32, wherein the applicator sprays, brushes, or dispenses the ink material onto a portion of the plurality of cells of the inking roll while the inking roll axially rotates.

Embodiment 34 is the method of any of embodiments 31 to 33, further including solidifying the ink material to form a printing pattern on the substrate.

Embodiment 35 is the method of any of embodiments 31 to 34, wherein contacting the rigid printing pattern with a substrate further includes providing an impression roll positioned adjacent to the printing roll to form a nip, and providing the substrate into the nip.

Embodiment 36 is the method of embodiment 35, wherein the impression roll includes an elastomeric material.

Embodiment 37 is the method of embodiment 35 or 36, wherein the impression roll includes a rubber, a foam, or a combination thereof.

Embodiment 38 is the method of any of embodiments 31 to 37, which is a roll-to-roll process.

Embodiment 39 is the method of any of embodiments 31 to 38, wherein the inking roll includes a shell layer and an elastomeric layer, wherein the shell layer is disposed around the elastomeric layer.

Embodiment 40 is the method of embodiment 39, wherein the elastomeric layer exhibits a modulus of 0.1 to 100 megapascals (MPa) or 0.1 MPa to 25 MPa.

Embodiment 41 is the method of embodiment 39 or embodiment 40, wherein the shell layer has a thickness of 1.27 centimeters (cm) or less or 1.00 cm or less.

Embodiment 42 is the method of any of embodiments 39 to 41, wherein the shell layer has a thickness of 0.127 cm or less and the elastomeric layer exhibits a modulus of 10 MPa or less.

Embodiment 43 is the method of any of embodiments 39 to 42, wherein the shell layer is composed of ceramic, metal, plastic, or rubber.

Embodiment 44 is the method of any of embodiments 39 to 43, wherein the shell layer includes chromium oxide ceramic, steel, a carbon fiber reinforced polymer (CFRP), a glass fiber reinforced polymer (GFRP), aluminum, ceramic coated copper, or chrome plated copper.

Embodiment 45 is the method of any of embodiments 39 to 43, wherein the shell layer is composed of nickel, stainless steel, copper, chrome, alloys, or a combination thereof.

Embodiment 46 is the method of any of embodiments 39 to 45, wherein the plurality of cells on the reversibly deformable surface each have a volume factor of 0.3 to 100 bcm or 0.3 to 40 bcm.

Embodiment 47 is the method of any of embodiments 39 to 46, wherein the elastomeric layer includes a rubber or a foam.

Embodiment 48 is the method of embodiment 47, wherein the foam includes a polyurethane foam, a polyester foam, a polyether foam, a filled or grafted polyether foam, a melamine foam, a polyethylene foam, a cross-linked polyethylene foam, a polypropylene foam, a silicone foam, or an ionomeric foam.

Embodiment 49 is the method of embodiment 47, wherein the rubber has a hardness in a range of 20 Shore A or greater to 90 Shore A or less.

Embodiment 50 is the method of any of embodiments 31 to 49, wherein the inking roll exhibits a length of elastic deformation of the elastically deformable surface upon contact with the printing roll.

Embodiment 51 is the method of embodiment 50, wherein the length of elastic deformation is 50 micrometers or greater or 125 micrometers or greater.

Embodiment 52 is the method of any of embodiments 31 to 51, wherein the printing roll comprises an outer layer disposed around a core.

Embodiment 53 is the method of embodiment 52, wherein the core includes a plastic or a metal.

Embodiment 54 is the method of embodiment 52 or embodiment 53, wherein the core includes stainless steel, aluminum, a carbon fiber reinforced polymer (CFRP), chrome or nickel plated multilayer steel-copper-steel, epoxy resin, or vinyl-ester epoxy resin.

Embodiment 55 is the method of any of embodiments 52 to 54, wherein the rigid printing pattern is formed on a surface of the outer layer.

Embodiment 56 is the method of any of embodiments 54 to 55, wherein the outer layer is composed of nickel, stainless steel, copper, chrome, alloys, or a combination thereof.

Embodiment 57 is the method of any of embodiments 52 to 56, wherein the outer layer includes two or more directly adjacent layers of metal.

Embodiment 58 is the method of any of embodiments 52 to 57, wherein the outer layer includes chromium oxide ceramic, or ceramic coated on any one of the following: steel, carbon fiber reinforced polymer (CFRP), glass fiber reinforced polymer (GFRP), aluminum, or copper.

Embodiment 59 is the method of any of embodiments 31 to 58, wherein the rigid printing pattern has a density of pattern features of up to 100% or up to 99%.

Embodiment 60 is the method of any of embodiments 31 to 59, wherein the rigid printing pattern includes pattern features having a width of 1 to 5 micrometers at a printing contact point.

Embodiment 61 is the method of any of embodiments 31 to 60, wherein the rigid printing pattern has a longitudinal gap between two pattern features of at least 5 centimeters and wherein the two pattern features each have a height of 0.1 millimeters or more at a printing contact point.

Embodiment 62 is the method of any of embodiments 31 to 61, wherein the rigid printing pattern has a pattern feature coverage of the total area of the rigid printing pattern of 1% to 5%.

Reference throughout this specification to “select embodiments”, “certain embodiments”, “some embodiments”, or “an embodiment”, whether or not including the term “exemplary” preceding the term “embodiment”, means that a particular feature, structure, material, or characteristic described in connection with the embodiment is included in at least one embodiment of the certain exemplary embodiments of the present disclosure. Thus, the appearances of these phrases in various places throughout this specification are not necessarily referring to the same embodiment of the certain exemplary embodiments of the present disclosure. Furthermore, the particular features, structures, materials, or characteristics may be combined in any suitable manner in one or more embodiments.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Example 1

To prepare the deformable anilox roller, a rubber sleeve about 15 to 20 cm in width and about 10 to 15 cm in outside diameter, commercially available as Load‘n’Lok from Luminite Products Corporation of Bradford, Pa., United States, was obtained. The rubber sleeve had surface textures (e.g., grooves) that allowed the rubber to deform into the grooves making the rubber more compressible near its outer surface. A Stork EcoSleeve was obtained from SPGPRINTS of Boxmeer, Netherlands at about 12 to 18 cm in width, about 10 to 15 cm in inside diameter, about 0.1 to 0.5 mm in thickness, and engraved at 5 BCM (billions of cubic microns) by SGS engraving (Sandstone, Va. was slid onto the rubber sleeve to achieve an interference fit therebetween.

To prepare the rigid printing stamp, a magnetic stainless-steel tool plate featuring squares and lines arranged in a patterned with a feature width of 15 to 30 micrometers was obtained from Flexible Cutting Systems from St. Louis, Mo., United States, and was mounted onto a magnetic steel mandrel, obtained from Wilson Manufacturing from Green Park, Mo., United States.

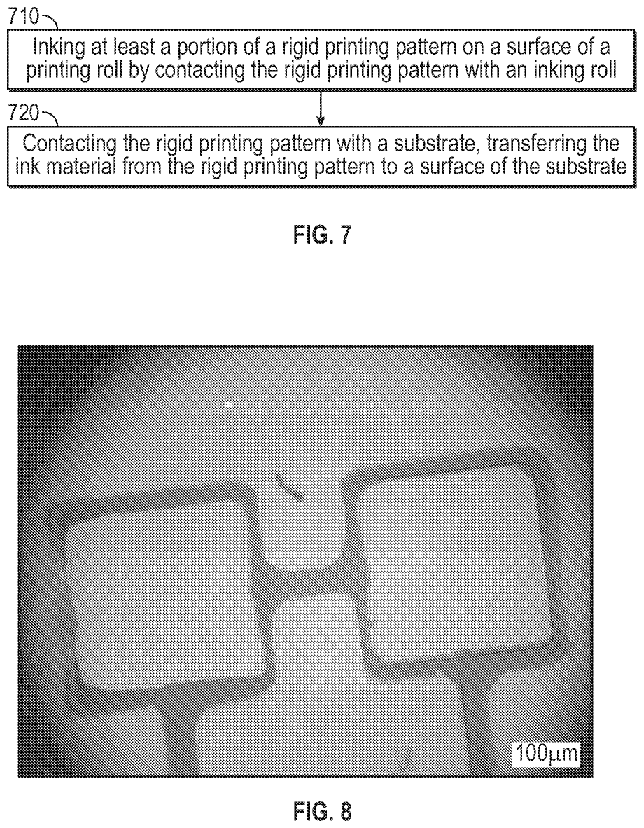

A 1.524 cm (6 inch) enclosed feed applicator purchased from Retroflex of Wrighton, Wis. United States was used to supply 9344 FR Process Black ink obtained from Nazdar Ink Technologies of Shawnee, Kans. United States to the deformable anilox roll. At a line speed of 7.62 meters per minute (25 feet per minute), the inked anilox roll was brought into contact with the rigid printing stamp roll until uniform inking was observed across the pattern. The rigid printing stamp was then nipped against a 0.0127 cm (0.005 inch) thick web wrapped around a steel impression roll with a 0.0127 cm (5 mil) gap, transferring the pattern from the rigid printing stamp to the web (as shown in FIG. 8). This material was then solidified using a UV curing chamber obtained from Xeric Web Drying System of Neenah, Wis., United States.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1-17. (canceled)

18. A printing system comprising:
a) a printing roll having a rigid printing pattern on a surface thereof configured to receive an ink material; and
b) an inking roll positioned adjacent to the printing roll, the inking roll comprising an elastically deformable surface and a plurality of cells disposed on the elastically deformable surface, wherein the inking roll comprises a shell layer and an elastomeric layer, wherein the shell layer is disposed around the elastomeric layer, and wherein the shell layer is composed of ceramic or metal, and wherein the shell layer has a Mohs hardness of 3 or greater.

19. The printing system of claim 18, further comprising an applicator configured to coat the ink material onto at least a portion of the elastically deformable surface of the inking roll.

20. The printing system of claim 18 wherein the elastomeric layer exhibits a modulus of 0.1 to 100 megapascals (MPa) or 0.1 MPa to 25 MPa.

21. The printing system of claim 18, wherein the shell layer comprises a thickness of 1.27 centimeters or less or 1.00 cm or less.

22. The printing system of claim 18, wherein the shell layer is composed of nickel, stainless steel, copper, chrome, alloys, or a combination thereof.

23. The printing system of claim 18, wherein the inking roll exhibits a length of elastic deformation of the elastically deformable surface upon contact with the printing roll, preferably 50 micrometers or greater or 125 micrometers or greater.

24. The printing system of claim 18, wherein the printing roll includes an outer layer disposed around a core and wherein the rigid printing pattern is formed on a surface of the outer layer.

25. The printing system of claim 24, wherein the outer layer is composed of nickel, stainless steel, copper, chrome, alloys, or a combination thereof.

26. The printing system of claim 18, further comprising an impression roll positioned adjacent to the printing roll to form a nip.

27. The printing system of claim 18, wherein the rigid printing pattern has a pattern feature coverage of the total area of the rigid printing pattern of 1 percent to 5 percent.

28. A method of printing comprising:
a) inking at least a portion of a rigid printing pattern on a surface of a printing roll by contacting the rigid printing pattern with an inking roll, the inking roll comprising an elastically deformable surface and a plurality of cells disposed on the elastically deformable surface, wherein the inking roll comprises a shell layer and an elastomeric layer, wherein the shell layer is disposed around the elastomeric layer, and wherein the shell layer is composed of ceramic or metal, and wherein the shell layer has a Mohs hardness of 3 or greater; and
b) contacting the rigid printing pattern with a substrate, transferring the ink material from the rigid printing pattern to a surface of the substrate.

29. The method of claim 28, further comprising transferring the ink material to at least a portion of the plurality of cells of the inking roll using an applicator, wherein the applicator sprays, brushes, or dispenses the ink material onto a portion of the plurality of cells of the inking roll while the inking roll axially rotates.

30. The method of claim 28, further comprising solidifying the ink material to form a printing pattern on the substrate.

31. The method of claim 28, wherein contacting the rigid printing pattern with a substrate further comprises providing an impression roll positioned adjacent to the printing roll to form a nip, and providing the substrate into the nip.

32. The method of claim 28, which is a roll-to-roll process.
